(19) United States
(12) Patent Application Publication
(10) Pub. No.: US 2026/0147641 A1
(43) Pub. Date: May 28, 2026

(54) REUSABLE BARRIER FOR SYNCHRONIZATION AMONG MULTIPLE PROCESSES

(71) Applicant: Hewlett Packard Enterprise Development LP, Spring, TX (US)

(72) Inventors: Ramesh Chandra Chaurasiya, Bangalore (IN); Subhra Sankar Kalita, Bangalore (IN)

(21) Appl. No.: 19/037,523

(22) Filed: Jan. 27, 2025

(30) Foreign Application Priority Data
Nov. 27, 2024 (IN) 202411092588

(51) Int. Cl. G06F 9/52; G06F 9/32; G06F 9/48

(52) U.S. Cl. CPC G06F 9/522; G06F 9/321; G06F 9/485

(57) ABSTRACT

One aspect provides a system and method for facilitating synchronization among processes. During operation, the system may execute, in parallel on one or more compute nodes, a plurality of processes. In response to a first process calling a barrier function, the system may pause execution of the first process, and in response to determining that the first process gains access to a variable shared by at least a subset of the plurality of processes, the system may update the shared variable. The system may release the shared variable to a second process in the subset to update the shared variable when the second process calls the barrier function and determine whether all processes in the subset have updated the shared variable. In response to the shared variable having been updated by all processes in the subset, the system may resume the execution of all processes in the subset.

### BACKGROUND

### Field

This disclosure relates to synchronization among a group of concurrently executed processes. More specifically, this disclosure relates to a reusable barrier mechanism to achieve synchronization among processes running distinct executable codes.

### Related Art

Efficient synchronization and communication among single-threaded processes, commonly known as Processing Elements (PEs), play a pivotal role in high-performance computing (HPC) environments. These mechanisms are essential for maximizing computational efficiency and safeguarding data integrity. In the realm of HPC, where complex calculations and massive data processing are the norm, the seamless coordination of PEs becomes paramount. By implementing effective synchronization strategies, HPC systems can orchestrate the execution of multiple processes with precision, minimizing idle time and optimizing resource utilization.

Many HPC applications leverage Message Passing Interface (MPI) programming to achieve optimal performance and scalability. The MPI programming model allows for a flexible approach where processes can execute distinct codes or programs on different data sets, a paradigm known as multiple program multiple data (MPMD) programming. This versatility enables developers to tailor their applications to complex computational tasks that require diverse algorithms or approaches. However, the adoption of MPMD can present significant challenges when working with certain parallel programming libraries (e.g., OpenSHMEM and Cray OpenSHMEMX).

### BRIEF DESCRIPTION OF THE FIGURES

FIG. 1 illustrates the operation principle of a reusable barrier system, according to one aspect of the instant disclosure.

FIG. 2 illustrates an example of multiple synchronization groups, according to one aspect of the instant disclosure.

FIG. 3 presents a flowchart illustrating example synchronization operations of a process implementing a reusable barrier system, according to one aspect of the instant disclosure.

FIG. 4 presents a flowchart illustrating an example operation process of a compute node executing a plurality of processes in parallel, according to one aspect of the instant disclosure.

FIG. 5 illustrates an example computer system facilitating synchronization among concurrent processes, according to one aspect of the instant disclosure.

FIG. 6 illustrates a computer-readable medium that facilitates synchronization among processes running different programs, according to one aspect of the instant application.

In the figures, like reference numerals refer to the same figure elements.

### DETAILED DESCRIPTION

Existing parallel-programming libraries based on shared memory (e.g., OpenSHMEM and Cray OpenSHMEMX) provide built-in synchronization mechanisms for processes running the same program (i.e., single program multiple data (SPMD)) but do not support synchronization among processes running different programs (i.e., MPMD). This is because, in the MPMD mode, various functionalities within these libraries are not fully functional. Without robust support for the MPMD mode, synchronization efforts are hindered, exacerbating challenges in coordinating processes running different programs. To overcome these challenges, according to some aspects of the instant disclosure, a novel reusable barrier system may be used to facilitate synchronization among processes running different programs on the same compute node or different compute nodes. This reusable barrier solution does not rely on the evolving functionalities of libraries and can provide a dependable synchronization mechanism today and in the future, enhancing system performance and reliability.

According to some aspects, the reusable barrier system may rely on a semaphore and shared memory to synchronize processes executing on the same compute node and rely on a remote lock mechanism and a remote memory (e.g., a fabric-attached memory (FAM)) to synchronize processes executing on different compute nodes. Using the single-node solution as an example, during operation, different processes may call a barrier function at different times and wait for all processes to reach the barrier point to advance. The caller of the barrier in each process may be configured to increment a global counter when it holds the semaphore. Because only one process can hold the semaphore at any given time, the counter may be incremented in a controlled fashion. A pointer to the counter may be mapped to a shared memory segment accessible by all processes. The barrier logic may determine whether all processes in a synchronization group have reached the barrier point by monitoring the counter value. The barrier system may be reused for future rounds of synchronization by introducing a “turn” value, where each process may update/increment its local “turn” value after all processes have reached the barrier point to advance to the next round of synchronization. Multiple barrier systems may be set up for different synchronization groups, with each group using its own semaphore and counter.

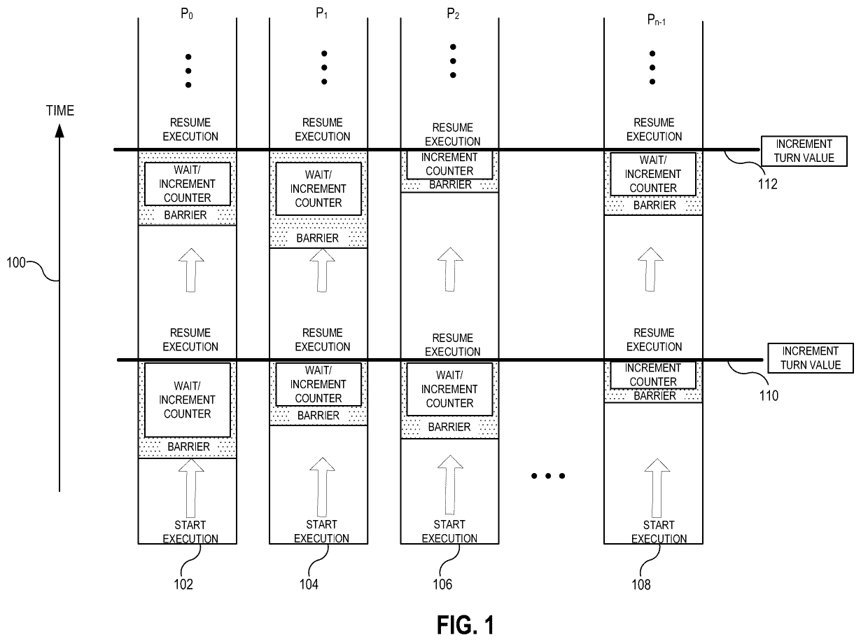

FIG. 1 illustrates the operation principle of a reusable barrier system, according to one aspect of the instant disclosure. More specifically, FIG. 1 shows the progress of a plurality of to-be-synchronized processes (e.g. processes 102-108) as time advances (the advance of the time is indicated by arrow 100). The processes may run different programs (e.g., different executable files) and may communicate with each other (e.g., exchange data). To ensure data consistency and correctness, a barrier system may be implemented. In one example, each program may include codes that call a barrier interface, causing the process to pause until all processes have reached the barrier point.

The concurrently running process may encounter the barrier (e.g., calling the barrier interface) at different times. In this example, process 102 encounters the barrier before all other processes (i.e., processing 104, 106, and 108) and waits for the other processes to reach the barrier point. While waiting, process 102 may also increment a global counter and monitor the counter value to determine whether all other processes have incremented the counter (i.e., have reached the barrier point). Similarly, when a different process (e.g., process 104 or 106) reaches the barrier point, it may also increment the counter and wait for other lagging processes. Subsequent to the last process (e.g., process 108) reaches the barrier point and increment counter, the barrier may be lifted to allow the processes to resume execution at a synchronization point 110. According to some aspects, the total increment to the counter value may be compared with the number of to-be-synchronized processes to determine whether all processes have incremented the global counter (i.e., have reached the barrier point). For example, if there are ten to-be-synchronized processes, and the global counter has been incremented ten times, then the barrier can be lifted as all ten processes have reached the barrier point.

The barrier system is reusable, meaning that the same data structures (e.g., the global counter and its mapping to the shared memory) may be used in subsequent rounds of synchronization. In some examples, the barrier system may use an additional variable (e.g., a turn value, starting from one) local to each process to track the number of synchronization rounds. In the example shown in FIG. 1, subsequent to determining that all processes have reached the barrier point, each process may increment the turn value to indicate that it advances into the next synchronization round.

In the example shown in FIG. 1, in the second round of synchronization, process 104 encounters the barrier (e.g., the program calls the barrier interface) the first, and process 106 encounters the barrier the last. Like in the previous round, each process may call the barrier interface and wait for other slower processes to reach the barrier point. Calling the barrier interface may lead to the increment of the global counter. By determining the increment to the global counter made in this round, each process may determine whether all processes have reached the barrier point. In some aspects, such a comparison may be made based on the global counter value and the local turn value. For example, the current counter value may be compared to the product of the total number of processes and the turn value. If the current counter value equals the product, all processes have reached the barrier point in this synchronization round. In one example, there are 5 processes, the current counter value is 23, and the current turn value is 5 (meaning it is the 5th synchronization round). Because the current counter value is less than the product of the number of processes and the number of synchronization rounds (i.e., 23<5×5), there are processes not yet arriving at the barrier point in the current synchronization round.

In some aspects, multiple barrier systems may be implemented to facilitate synchronization among different groups of processes. In this implementation, each synchronization group may include a subset of concurrently running processes and may rely on a unique data structure (e.g., the global counter value and local turn value) corresponding to that group to synchronize processes within the group.

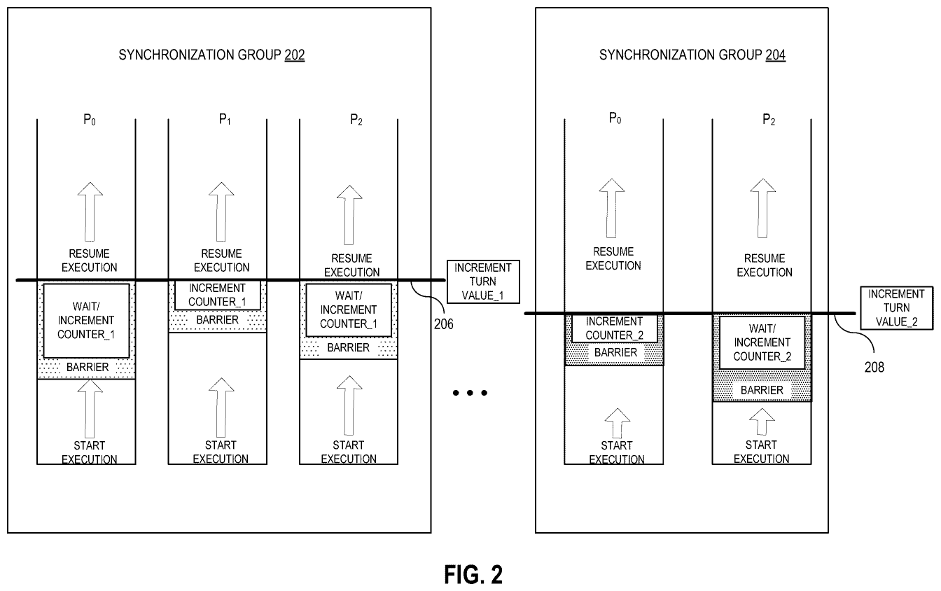

FIG. 2 illustrates an example of multiple synchronization groups, according to one aspect of the instant disclosure. In this example, the concurrent processes may be grouped into multiple synchronization groups, including synchronization groups 202 and 204. These groups may overlap, meaning that a particular process may participate in multiple groups. In this example, synchronization group 202 includes processes P₀, P₁, and P₂, and synchronization group 204 includes processes P₀ and P₂. In this example, process P₀ and P₂ are in both groups.

Synchronization group 202 may implement a reusable barrier system that includes a global counter (e.g., counter_1) accessible to all processes in the group and a turn variable (e.g., turn value_1) local to each process. During each turn of the synchronization, a process calling the barrier interface may update the global counter value. For example, process P₀ arrives at the barrier point before processes P₁ and P₂ and calls the barrier interface. While waiting for P₁ and P₂, process P₀ may increment the global counter (e.g., the value of counter_1). Similarly, process P₂ may increment counter_1 while waiting for process P₁ to call the barrier. In response to determining that all processes within synchronization group 202 have reached the barrier point (i.e., have incremented counter_1), each process in the group may increment its own turn variable (e.g., turn value_1). The barrier may then be lifted at synchronization point 206, and all processes may resume execution. The updated local turn values (e.g., turn value_1) may be used in the subsequent synchronization round to determine whether all processes in synchronization group 202 have reached the barrier point.

The reusable barrier system implemented in synchronization group 204 may include a different counter (e.g., counter_2) and a different turn variable (e.g., turn value_2). In this example, process P₂ encounters the barrier first. While waiting for process P₀, process P₂ increments counter_2. When process P₂ arrives at the barrier point, it calls the barrier interface to increment counter_2. After counter_2 is incremented by both processes, each process (e.g., P₀ or P₂) may subsequently increment its local turn variable, (e.g., turn value_2). The barrier may be lifted at synchronization point 208, and all processes in the group may resume execution. The updated local turn values (e.g., turn value_2) may be used in a subsequent synchronization round to determine whether all processes in synchronization group 204 have reached the barrier point.

In some aspects, to prevent racing conditions associated with the global counter, the reusable barrier system may implement a semaphore (when the processes are running on a single node) to control access to the global counter. Semaphores have been used as a signaling mechanism to coordinate the execution order of multiple processes executing the same program. In some aspects of the instant disclosure, the reusable barrier system for processes running different programs may use a binary semaphore to ensure that only one process can increment the global counter such that the instant counter value can reflect the number of processes reaching the barrier point. More specifically, when a process calls the barrier, it has to check whether it holds the semaphore (e.g., whether the semaphore value is 1). Note that the initial value of the semaphore may be set as 1, such that the process calls the barrier the first will hold the semaphore and exclude other processes from holding the semaphore (e.g., by setting the semaphore value to 0). A process may increment the global counter if and only if it holds the semaphore. After incrementing the global counter, the process may release the semaphore (e.g., by resetting its value to 1) to allow a different process to hold the semaphore to increment the global counter.

When the processes are running on multiple nodes, the reusable barrier system may implement a remote lock to control access to a global counter. Note that a remote lock is a synchronization mechanism that allows a process to acquire a lock on a resource that is managed by a dedicated server core or node, rather than competing directly with other processes for the lock. According to some aspects, the reusable barrier system may implement a remote lock using any distributed locking primitive. In one example, a remote lock may be implemented using a centralized lock manager or a distributed consensus algorithm. A process attempts to acquire the lock before accessing a shared resource. If successful, the process performs its critical section operations and then release the remote lock to allow other processes to acquire the lock.

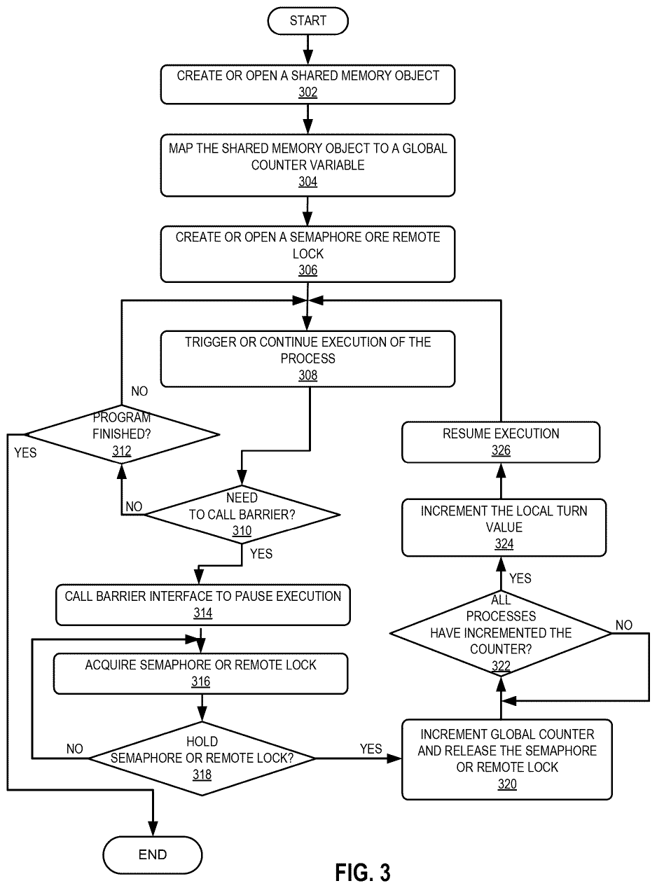

FIG. 3 presents a flowchart illustrating example synchronization operations of a process implementing a reusable barrier system, according to one aspect of the instant disclosure. The process may be one of a plurality of processes executing in parallel on a compute node. The reusable barrier system may include data structures (e.g., a global counter) created in the shared memory and functions (e.g., a barrier function) embedded in the executable codes.

During operation, to initialize the reusable barrier system, a process may create or open (e.g., by calling shm_open( ) provided by a standard C library for the single-node solution) a shared memory object (operation 302). If the shared memory object exists, the process opens the object; otherwise, it creates the object. The shared memory object may be accessible by all participating processes running different programs. The processes may be executed on different processors of one or more compute nodes. In one example, the shared memory object may be open or created with read/write access. Creating the shared memory may also include storing the file descriptor and setting its size to hold an integer.

Example codes for creating/opening the share memory object are listed below:

```
  netma_shm_fd
    = shm_open(“/netma_global_barrier_shm”,
      O_CREAT | O_RDWR,
      0666);
ftruncate(netma_shm_fd, sizeof(int)).
```

The process may subsequently map the shared memory object to a global counter variable (operation 304). In one example, the shared memory object may be mapped (e.g., by making the mmap( ) system call) to the global counter variable as an integer pointer with read/write access. Example codes for the memory mapping are listed below:

```
netma_global_counter
  = (int *)mmap(NULL,
    sizeof(int),
    PROT_READ | PROT_WRITE,
    MAP_SHARED,
    netma_shm_fd,
    0).
```

Note that the MAP_SHARED flag in the above mmap( ) function indicates that updates to the mapping are visible to other processes mapping the same region. On success, mmap( ) returns a pointer (e.g., the pointer to the global counter) to the mapped area. This operation essentially stores the pointer to the global counter in the shared memory.

The process may subsequently create or open a semaphore or remote lock (operation 306). The semaphore may be created with read/write permissions with an initial value set as 1. Example codes for creating the semaphore are listed below:

netma_sem
= sem_open(“/netma_global_barrier_sem”, O_CREAT, 0666, 1).

Note that a semaphore is used here for the single-node solution. When the to-be-synchronized processes are executing on multiple nodes, a remote lock mechanism (e.g., any distributed locking primitive) may be used to control access to the global counter. The process creates a semaphore/remote lock if there is no semaphore/remote lock in the system. Otherwise, the process may open an existing semaphore/remote lock.

The system may trigger or continue the execution of the process (operation 308) and determine whether a call to the barrier is needed (operation 310). When the process advances to the barrier point (e.g., a code section that includes the barrier function), the system calls the barrier. If not, the system may determine whether the program is finished (operation 312). A program is finished when it successfully executes all its instructions or when a termination condition is triggered (e.g., when it encounters a predetermined event or state). If so, the process ends. If not, the system continues the execution of the process. If a call to the barrier is needed, the process may call the barrier interface to pause execution (operation 314). The process may attempt to acquire the semaphore (for the single-node solution) or the remote lock (for the multi-node solution) (operation 316). In one example, the process may call the barrier interface using a number of variables, including the number of processes, the semaphore or remote lock, the counter, and a turn variable. Example codes for calling the barrier are listed below:

```
netma_barrier(netma_sem,
  netma_global_counter,
  &netma_local_turn,
  number_of_processes_in_group).
```

When the barrier function is called, the process pauses execution and determines whether it holds the semaphore (for the single-node solution) or a remote lock (for the multi-node solution) (operation 318). In one example of the single-node solution, determining whether a process holds the semaphore may comprise determining whether the current value of the semaphore is 1. If not, the process attempts to acquire the semaphore or remote lock (operation 318). If the process holds the semaphore (e.g., semaphore=1) or remote lock, it increments the counter (e.g., by one or other predetermined values) and release the semaphore or remote lock (operation 320).

The process may further determine whether all processes in the synchronization group have incremented the global counter in the current round of synchronization (operation 322). In one example, the process may compare the current counter value with the product of the current turn value and the number of processes. If the current counter value equals the product of the current turn value and the number of processes in the synchronization group, all processes in the group have incremented the global counter, indicating that they have all reached the barrier point. Accordingly, the process may increment its local turn value (operation 324). Otherwise, the process waits until all other processes have incremented the global counter (operation 322). In one example, all processes increment their local turn values such that those turn values are synchronized to be used in the next round of synchronization. In one example, all processes may increment their local turn values by a predetermined amount (e.g., by one). The process may subsequently resume execution (operation 326) and continue to operation 308. The barrier system (i.e., the data structures like the global counter and semaphore) may be reused for subsequent synchronization rounds. Example codes for the barrier function are listed below:

```
void netma_barrier(sem_t *sem, int *counter, int *turn, int
total_processes)
{
  sem_wait(sem);
  (*counter)++;
  if (*counter == (total_processes*(*turn))) {
    (*turn)++;
    sem_post(sem);
  } else {
    sem_post(sem);
    while (*counter < (total_processes*(*turn))) {
      sched_yield( );
    }
    (*turn)++;
  }
  return;
}
```

In the example shown in FIG. 3, a single barrier system is implemented. In alternative examples, concurrently executing processes may be grouped into multiple (and possibly overlapping) synchronization groups that implement multiple barriers, similar to the example shown in FIG. 2. In such a case, multiple unique data structures may be set up during the initialization of the barrier system. For example, operations 302 through 306 may be performed for the different barriers. If a process participates in multiple synchronization groups, that particular process may perform operations 302 through 306 multiple times, one for each synchronization group (e.g., synchronization group 202 or 204 shown in FIG. 2).

For a particular synchronization group, the barrier interface may be called using variables specific to the group, including the number of processes in the synchronization group, the semaphore/remote lock, the counter, and the turn variable. When multiple barrier systems are implemented, the execution order of the processes may be determined by all barriers. In the example shown in FIG. 2, processes P₀ and P₂ may first be synchronized at synchronization point 208 without considering the progress of process P₁. Subsequently, processes P₀ and P₂ resume execution until they each call the barrier for synchronization group 202. All three processes (i.e., P₀, P₁, and P₂) may then be synchronized at synchronization point 206.

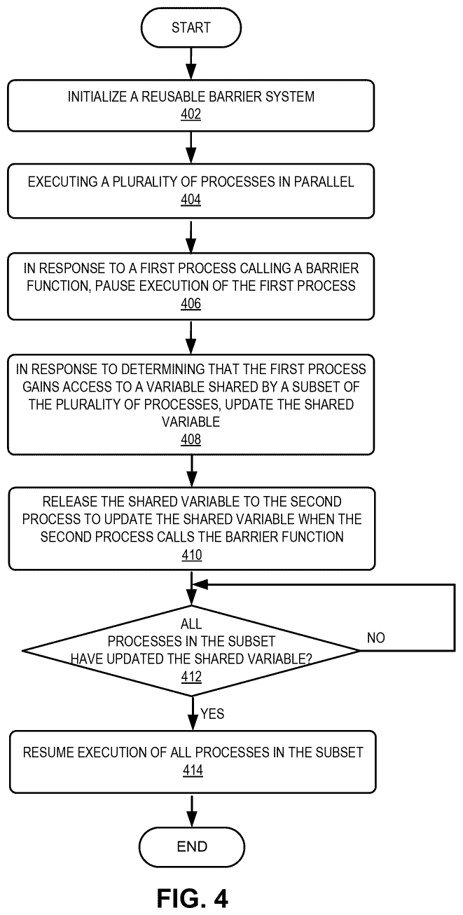

FIG. 4 presents a flowchart illustrating an example operation process of a compute node executing a plurality of processes in parallel, according to one aspect of the instant disclosure. The compute node may implement a reusable barrier system to synchronize the processes. The reusable barrier system may include data structures created in a shared memory and functions embedded in each process participating in a synchronization group. Compared with conventional barriers that only work with processes running the same program (or executables), the disclosed reusable barrier system may synchronize processes running different programs on one or more compute nodes. Moreover, the same data structures may be used for multiple rounds of synchronization.

The operation starts with the initialization of the reusable barrier system (operation 402). According to some aspects, initializing the reusable barrier system comprises creating or opening, by each to-be-synchronized process, a shared memory object with read and write accesses, storing the file descriptor (e.g., a reference ID) of the shared memory object, and setting the size of the file descriptor to hold an integer. The initialization may include mapping, by each process, the shared memory to a global counter variable as an integer pointer with read and write accesses. The mapping may be flagged as shared, such that updates to the mapping are visible to all processes mapping the same memory region. The initialization may further include, for the single-node solution, opening or creating, in each process, a semaphore with read and write permissions. The initial value of the semaphore may be set as one. For the multi-node solution, the initialization may include setting up metadata for remote lock usage.

Subsequent to initializing the reusable barrier system, the compute node may execute a plurality of processes in parallel (operation 404). The processes may run different programs (e.g., with different computer-executable codes) and may exchange data during execution. To ensure data consistency and correctness, the processes may need to be synchronized using the reusable barrier system.

Different processes may progress differently and encounter the barrier (i.e., call the barrier function) at different time instants. In response to a first process calling the barrier function, the compute node may pause the execution of the first process (operation 406). Pausing the execution allows the first process to wait for other processes in a synchronization group to catch up.

In response to determining that the first process gains access to a variable shared by a subset of the plurality of processes, the compute node may update the shared variable (operation 408). According to some aspects, the first process may participate in a synchronization group comprising a subset of the processes. Processes in the synchronization group may call the barrier function to synchronize at predetermined critical points. According to some aspects, determining that the first process gains access to the shared variable comprises determining that the first process holds the semaphore (e.g., the current semaphore value is one). The shared variable may comprise a global counter, and updating the shared variable may comprise incrementing the global counter by a predetermined value (e.g., one). A pointer to the global counter may be mapped to a shared memory segment that is accessible to all processes in the subset.

Subsequently, the first process may release the shared variable to the second process to update the shared variable when the second process calls the barrier function (operation 410). Releasing the shared variable may comprise releasing the semaphore (e.g., by resetting the semaphore value to one).

The compute node may determine whether all processes in the subset have updated the shared variable (operation 412). According to one aspect, the compute node may compare the increment to the global counter made within the current synchronization round with the number of processes in the synchronization group. The increment value to the global counter equals the number of processes if all processes have called the barrier function and increment the global counter. According to further aspects, an additional local variable (i.e., turn value) may be used to determine the number of synchronization rounds starting from the beginning of the execution of the processes. In such a case, each process executing on the compute node may compare the current counter value with a product of the current turn value and the total number of the processes in the subset.

If all processes in the subset have updated the shared variable, the compute node may resume the execution of all processes in the subset (operation 414). Otherwise, the compute node waits for all processes to catch up (i.e., call the barrier function and update the shared variable).

In the examples shown in FIGS. 1-3, the to-be-synchronized processes may be executed on one compute node (e.g., on one or more processors of the compute node) that implements a shared memory accessible by all processors. In alternative examples, the to-be-executed processes may be executed on different compute nodes without a shared memory. In such a case, processes executing on the different compute nodes may access a remote memory like a fabric-attached memory (FAM). Interfaces provided by some libraries (e.g., OpenFAM) may be used to facilitate data access and synchronization in the remote memory (e.g., FAM) across multiple processes.

For example, instead of a semaphore, the reusable barrier system may use remote lock to control access to the critical section (e.g., the one that increments the global counter). A remote lock may be any distributed locking primitive that can be used to coordinate access to remotely shared variables. After acquiring the remote lock, the process may enter the critical section, where the remotely shared counter can be incremented. In the lock release path, instead of sem_post( ) remote unlock may be used. The global counter may include any remote variable (e.g., a FAM variable) visible to the processes executing on the different nodes. The other data structures used in the barrier system (i.e., the turn value and the number of processes in the synchronization group) may remain unchanged, as the turn value is a variable local to a process, and the number of processes is constant for each group.

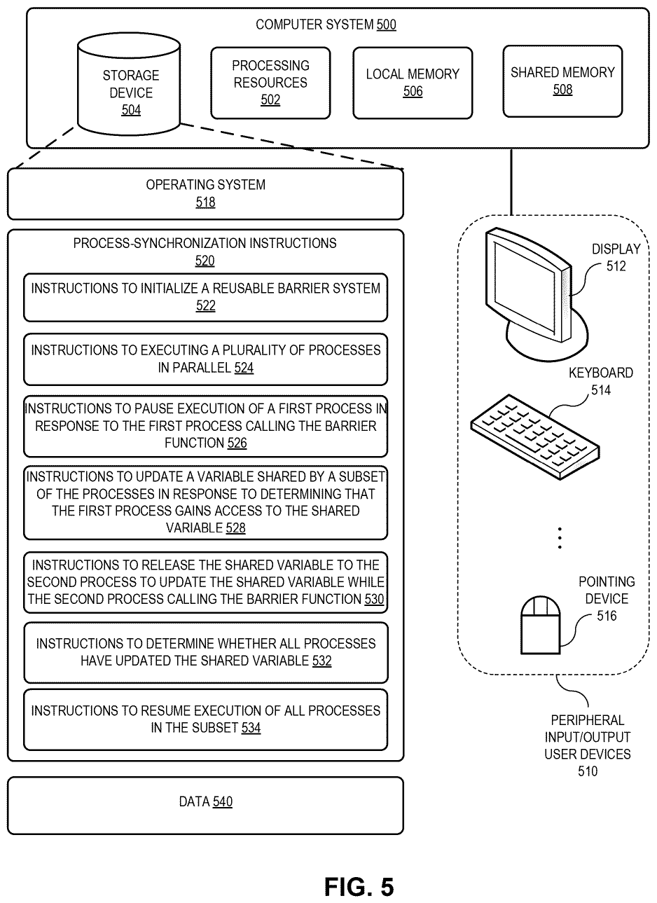

FIG. 5 illustrates an example computer system facilitating synchronization among concurrent processes, according to one aspect of the instant disclosure. Computer system 500 may include one or more processing resources (e.g., a processing resource 502), one or more storage devices (e.g., storage device 504), a private memory 506, and a shared memory 508.

In the examples described herein, a processing resource may include, for example, one processor or multiple processors included in a single computing device or distributed across multiple computing devices. In some examples, the concurrent processes may be executed on a single computing device or multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Computer system 500 can be coupled to peripheral I/O user devices 510 (e.g., a display device 512, a keyboard 514, and a pointing device 516). Storage device 504 includes a non-transitory computer-readable storage medium and stores an operating system 518, process-synchronization instructions 520, and data 540. Computer system 500 may include fewer or more entities than those shown in FIG. 5.

Process-synchronization instructions 520 may include instructions, which when executed by computer system 500, can cause computer system 500 to perform methods and/or processes described in this disclosure. Process-synchronization instructions 520 can be executed at least on processing resource 502.

Process-synchronization instructions 520 may include instructions 522 to initialize a reusable barrier system, as described above in relation to operations 302-306 shown in FIG. 3 and operation 402 shown in FIG. 4. The reusable barrier system may include data structures created in a shared memory (for the single-node solution) or a remote memory (for the multi-node solution) and functions embedded in each process participating in the synchronization operation. For the single-node solution, instructions 522 may include instructions to set up a shared memory object, instructions to map the shared memory to a global counter variable as an integer pointer with read and write accesses, and instructions to set up a semaphore with read and write permissions. For the multi-node solution, instructions 522 may include instructions to set up a remote lock.

Process-synchronization instructions 520 may include instructions 524 to execute a plurality of processes in parallel, as described above in relation to operation 404 shown in FIG. 4. The processes may run different programs (e.g., with different computer-executable codes) on the same computing device or multiple computing devices.

Process-synchronization instructions 520 may include instructions 526 to pause the execution of a first process responsive to the first process calling the barrier function, as described above in relation to operations 310 and 312 shown in FIG. 3 and operation 406 shown in FIG. 4. Different processes may encounter the barrier at different time instants.

Process-synchronization instructions 520 may include instructions 528 to update a variable shared by a subset of the plurality of processes in response to determining that the first process gains access to the share variable, as described above in relation to operations 314 and 316 shown in FIG. 3 and operation 408 shown in FIG. 4. For the single-node solution, instructions 528 may include instructions to determine whether the first process holds the semaphore and instructions to increment a counter variable accessible to all processes in the subset if the first process holds the semaphore. For the multi-node solution, instructions 528 may include instructions to determine whether the first process holds the remote lock,

Process-synchronization instructions 520 may include instructions 530 to release the shared variable to the second process to update the shared variable when the second process calls the barrier function, as described above in relation to operation 410 shown in FIG. 4. More specifically, instructions 530 may include instructions to release the semaphore or remote lock to the second process.

Process-synchronization instructions 520 may include instructions 532 to determine whether all processes in the subset have updated the shared variable, as described above in relation to operation 318 shown in FIG. 3 and operation 412 shown in FIG. 4. More specifically, instructions 530 may include instructions to compare the amount of increment to the global counter with the number of processes in the subset. When multiple synchronization rounds have been performed, instructions 530 may be used to compare the current counter value with a product of the current turn value and the total number of the processes in the subset.

Process-synchronization instructions 520 may include instructions 534 to resume execution of all processes in the subset in response to determining that all processes in the subset have updated the shared variable, as described above in relation to operation 322 shown in FIG. 3 and operation 414 shown in FIG. 4.

Process-synchronization instructions 520 may include more instructions than those shown in FIG. 4. For example, Process-synchronization instructions 520 may include instructions to increment (e.g., by one) a turn value in response to determining that all processes in the subset have updated the shared variable.

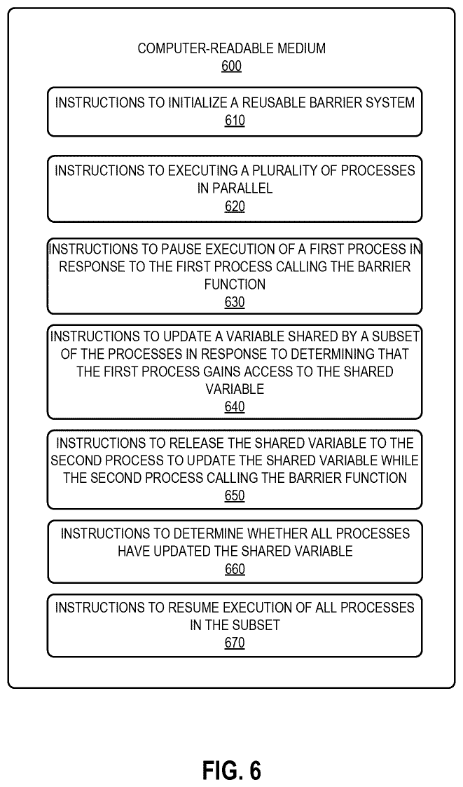

FIG. 6 illustrates a computer-readable medium that facilitates synchronization among processes running different programs, according to one aspect of the instant application. CRM 600 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 600 may store instructions 610 to initialize a reusable barrier system, as described above in relation to operations 302-306 shown in FIG. 3 and operation 402 shown in FIG. 4; instructions 620 to execute a plurality of processes in parallel, as described above in relation to operation 404 shown in FIG. 4; instructions 630 to pause the execution of a first process responsive to the first process calling the barrier function, as described above in relation to operations 310 and 312 shown in FIG. 3 and operation 406 shown in FIG. 4; instructions 640 to update a variable shared by a subset of the plurality of processes in response to determining that the first process gains access to the shared variable, as described above in relation to operations 314 and 316 shown in FIG. 3 and operation 408 shown in FIG. 4; instructions 650 to release the shared variable to the second process to update the shared variable when the second process calls the barrier function, as described above in relation to operation 410 shown in FIG. 4; instructions 660 to determine whether all processes in the subset have updated the shared variable, as described above in relation to operation 318 shown in FIG. 3 and operation 412 shown in FIG. 4; and instructions 660 to resume execution of all processes in the subset in response to determining that all processes in the subset have updated the shared variable, as described above in relation to operation 322 shown in FIG. 3 and operation 414 shown in FIG. 4.

CRM 600 may include more instructions than those shown in FIG. 6. For example, CRM 600 may include instructions to increment (e.g., by one) a turn value in response to determining that all processes in the subset have updated the shared variable.

The reusable barrier system provides a number of advantages, including but not limited to flexibility (it may facilitate efficient synchronization across processes running different programs on the same compute node or different compute nodes), simplicity (it introduces a straightforward implementation that simplifies process synchronization without relying on SHMEM calls overhead), optimization of resources (it minimizes resource consumption and enhances overall system performance by reusing synchronization mechanisms across multiple synchronization points), and independence from library completion. While the existing libraries may continue to evolve and enhance their support for MPMD mode, the reusable barrier system may provide a resilient alternative for ensuring effective process synchronization. Its adaptability and reliability make it a valuable asset for advancing HPC capabilities beyond current library limitations.

In general, aspects of the instant disclosure provide a solution to the technical problem of synchronizing processes running different programs on a single compute node or multiple compute nodes. More specifically, a reusable barrier system that may be implemented without relying on (or waiting for the completion of) functions in existing programming libraries (OpenSHMEM and Cray-OpenSHMEMx libraries) to allow developers of newer generation network interface controllers (NICs) to conduct pre-silicon validation using a network simulator in MPMD mode. When the processes are executing on the same node, the reusable barrier system may rely on a semaphore and a global counter mapped to the shared memory to synchronize the processes. When the processes are executing on different nodes, the reusable barrier system may rely on the remote (distributed) lock mechanism (instead of the semaphore) and a remote variable (e.g., a FAM variable) to synchronize the processes.

One aspect of the instant application provides a system and method for facilitating synchronization among processes. During operation, the system may execute, in parallel on a compute node, a plurality of processes. In response to a first process calling a barrier function, the system may pause execution of the first process, and in response to determining that the first process gains access to a variable shared by at least a subset of the plurality of processes, the system may update the shared variable. The system may release the shared variable to a second process in the subset to update the shared variable when the second process calls the barrier function. The system may determine whether all processes in the subset have updated the shared variable. In response to the shared variable having been updated by all processes in the subset, the system may resume the execution of all processes in the subset.

In a variation on this aspect, determining that the first process gains access to the shared variable may include determining that the first process holds a semaphore.

In a variation on this aspect, the shared variable may include a global counter value, and updating the shared variable may include incrementing the global counter value.

In a further variation, determining whether all processes in the subset have updated the shared variable may include determining a current global counter value.

In a further variation, the system may increment a turn value by each process in the subset subsequent to determining that all processes in the subset have updated the shared variable, and determining whether all processes in the subset have updated the shared variable may include comparing the current global counter value with a product of the current turn value and a total number of the processes in the subset.

In a further variation, the global counter value is mapped to a pointer to a shared memory segment associated with a respective process.

In a variation on this aspect, the processes in the subset form a first synchronization group. The system may create a second synchronization group comprising a second subset of the plurality of processes, and a respective process in the second subset is to update a second variable shared by all processes in the second subset.

In a variation on this aspect, at least two processes in the subset are running different computer-executable codes.

One aspect of the instant application provides a computer system comprising a processing resource and a non-transitory machine-readable storage medium comprising instructions executable by the processing resource to execute, in parallel, a plurality of processes; pause execution of a first process in response to the first process calling a barrier function; in response to determining that the first process gains access to a variable shared by at least a subset of the plurality of processes, update the shared variable; release the shared variable to a second process in the subset to update the shared variable when the second process calls the barrier function; determine whether all processes in the subset have updated the shared variable; and in response to the shared variable having been updated by all processes in the subset, resume the execution of all processes in the subset.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
executing, in parallel on one or more compute nodes, a plurality of processes;
in response to a first process calling a barrier function, pausing execution of the first process;
in response to determining that the first process gains access to a variable shared by at least a subset of the plurality of processes, updating the shared variable;
releasing the shared variable to a second process in the subset;
updating the shared variable when the second process calls the barrier function;
determining whether all processes in the subset have updated the shared variable;
in response to the shared variable having been updated by all processes in the subset, resuming the execution of all processes in the subset.

2. The computer-implemented method of claim 1, wherein determining that the first process gains access to the shared variable comprises determining that the first process holds a semaphore or a remote lock.

3. The computer-implemented method of claim 1, wherein the shared variable comprises a global counter value, and wherein updating the shared variable comprises incrementing the global counter value.

4. The computer-implemented method of claim 3, wherein determining whether all processes in the subset have updated the shared variable comprises determining a current global counter value.

5. The computer-implemented method of claim 4, further comprising:
incrementing a turn value by each process in the subset subsequent to determining that all processes in the subset have updated the shared variable; and
wherein determining whether all processes in the subset have updated the shared variable comprises comparing the current global counter value with a product of the current turn value and a total number of the processes in the subset.

6. The computer-implemented method of claim 3, wherein the global counter value is mapped to a pointer to a shared memory segment associated with a respective process.

7. The computer-implemented method of claim 1, wherein the processes in the subset form a first synchronization group, wherein the method further comprises creating a second synchronization group comprising a second subset of the plurality of processes, and wherein a respective process in the second subset updates a second variable shared by all processes in the second subset.

8. The computer-implemented method of claim 1, wherein at least two processes in the subset are running different computer-executable codes.

9. A computer system, comprising:
one or more processing resources; and
a non-transitory machine-readable storage medium comprising instructions executable by the processing resources to:
execute, in parallel, a plurality of processes;
pause execution of a first process in response to the first process calling a barrier function;
in response to determining that the first process gains access to a variable shared by at least a subset of the plurality of processes, update the shared variable;
release the shared variable to a second process in the subset;
update the shared variable when the second process calls the barrier function;
determine whether all processes in the subset have updated the shared variable; and
in response to the shared variable having been updated by all processes in the subset, resume the execution of all processes in the subset.

10. The computer system of claim 9, wherein determining that the first process gains access to the shared variable comprises determining that the first process holds a semaphore or a remote lock.

11. The computer system of claim 9, wherein the shared variable comprises a global counter value, and wherein updating the shared variable comprises incrementing the global counter value.

12. The computer system of claim 11, wherein determining whether all processes in the subset have updated the shared variable comprises determining a current global counter value.

13. The computer system of claim 12,
wherein the non-transitory machine-readable storage medium further comprises instructions executable by the processing resource to increment a turn value by each process in the subset subsequent to determining that all processes in the subset have updated the shared variable; and
wherein determining whether all processes in the subset have updated the shared variable comprises comparing the current global counter value with a product of the current turn value and a total number of the processes in the subset.

14. The computer system of claim 11, wherein the global counter value is mapped to a pointer to a shared memory segment associated with a respective process.

15. The computer system of claim 9, wherein the processes in the subset form a first synchronization group, wherein the non-transitory machine-readable storage medium further comprises instructions executable by the processing resource to create a second synchronization group comprising a second subset of the plurality of processes, and wherein a respective process in the second subset updates a second variable shared by all processes in the second subset.

16. The computer system of claim 9, wherein at least two processes in the subset are running different computer-executable codes.

17. A non-transitory computer-readable storage medium storing instructions to:
execute, in parallel on one or more compute nodes, a plurality of processes;
pause execution of a first process in response to the first process calling a barrier function;
in response to determining that the first process gains access to a variable shared by at least a subset of the plurality of processes, update the shared variable;
release the shared variable to a second process in the subset;
update the shared variable when the second process calls the barrier function;
determine whether all processes in the subset have updated the shared variable; and
in response to the shared variable having been updated by all processes in the subset, resume the execution of all processes in the subset.

18. The non-transitory computer-readable storage medium of claim 17, wherein determining that the first process gains access to the shared variable comprises determining that the first process holds a semaphore or a remote lock.

19. The non-transitory computer-readable storage medium of claim 17, wherein the shared variable comprises a global counter value, and wherein updating the shared variable comprises incrementing the global counter value, and wherein determining whether all processes in the subset have updated the shared variable comprises determining a current global counter value.

20. The non-transitory computer-readable storage medium of claim 19, wherein the instructions are further to:
increment a turn value by each process in the subset subsequent to determining that all processes in the subset have updated the shared variable; and
wherein determining whether all processes in the subset have updated the shared variable comprises comparing the current global counter value with a product of the current turn value and a total number of the processes in the subset.
